(19) United States
(12) Patent Application Publication
(10) Pub. No.: US 2024/0094432 A1
(43) Pub. Date: Mar. 21, 2024

(54) Geological Neural Network Methodology (Geo-Net) For Reservoir Optimization And Assisted History Match

(71) Applicant: OriGen Al, Brooklyn, NY (US)

(72) Inventors: Ruben Rodriguez Torrado, Hoboken, NJ (US); Alberto Pumar Jimenez, Seville (ES)

(21) Appl. No.: 18/244,711

(22) Filed: Sep. 11, 2023

Related U.S. Application Data
(60) Provisional application No. 63/405,138, filed on Sep. 9, 2022.

(51) Int. Cl. G01V 99/00

(52) U.S. Cl. CPC G01V 99/005

(57) ABSTRACT

An apparatus for computing is presented that includes an input interface to receive a geological model, the geological model representative of a geological volume. The apparatus further includes a processor implementing a DNN, the processor configured to generate a probabilistic geological model that includes, for each cell, and for a set of facies, a probability of the cell being each of the facies, given the geological model and predetermined conditions, and an output interface. The conditions include: a style image, and hard data for regions of the geological volume. Further, a method includes obtaining a reconstruction of (i) a PCA vector obtained from a geological model, and (ii) a perturbed PCA vector created from the model, computing a set of NN weights for each of the reconstructioned vectors, computing a total loss, based on the respective NN weights, and computing an NN backpropagation based upon the total loss.

### CROSS-REFERENCE TO OTHER APPLICATIONS

This application claims the benefit of U.S. Provisional Patent Application No. 63/405,138, filed on Sep. 9, 2022, the entire disclosure of which is incorporated herein by reference.

### TECHNICAL FIELD

The present invention is directed to deep neural networks, and in particular to a combination of an improved deep neural network and an optimizer for reservoir optimization and automatic history match (“AHM”) for use in oil reservoir analysis.

### BACKGROUND OF THE INVENTION

Reservoir model inversion, also known as history matching (HM) in the petroleum engineering community, involves the calibration of one or multiple models with respect to measurement data (usually, for example, well-log, and well injection and production data). Thus, these models can be used to make better production forecasts. These models divide a reservoir's 3D space into cells. A typical model may have millions of cells, such as, for example, 6 M cells. These models, however, are built using actual data from hundreds of wells spread throughout the volume, which occupy a very small percentage of the actual reservoir volume. As a result, values of relevant variables in most of the cells of a model are the result of interpolation. Concretely, HM involves estimating model parameters, such as permeability or porosity, in every grid cell of the model such that the porous media simulation outputs closely follow the observed data. Since there are typically more degrees of freedom in the calibration than in the measurement data, the problem is ill-conditioned, and many solutions that match the data within an acceptable level of accuracy can be found. Given the problematic nature of reservoir model inversion, one approach is to obtain multiple history-matched solutions and consider all of them to generate (probabilistic) predictions. Subsequent decisions (e.g., locations of future wells) are made based on statistics computed from these predictions. HM algorithms combined with parametrization of the geological variables based on principle component analysis (PCA) become more efficient as they diminish the total number of parameters that have to be discovered through data assimilation, and the spatial correlation structure of the hard data is preserved.

Traditionally, HM has been approached in a somewhat ad-hoc manner (Oliver & Chen, 2011). For example, through the tuning of multipliers associated with polyhedral regions or patches in the reservoir where the matching is not deemed satisfactory. One of the main limitations of this approach is the lack of geological plausibility. In other words, in some situations approximated models might not be perceived as acceptable solutions because they may not be fully consistent with the statistics of the model (e.g., histogram, variogram, etc.). An added drawback is the time and effort necessary to carry out such an ad-hoc HM. Usually, a reservoir engineer needs to define and modify patches manually and run expensive reservoir simulations. These may take hours, or even days. This workflow is prohibitively expensive, and can take months to complete an HM for reservoirs with hundreds of wells. Subsequently, this limits its use for updating models when new geological information is received from the field (data assimilation), (Jung et al., 2018).

Alternatively, optimization methods can be used to automatically find a geological realization that matches the historical data. However, each of these methods has significant drawbacks.

Thus, an improved history matching approach is needed, that overcomes the problems in the art.

### SUMMARY OF THE INVENTION

Full history match models in subsurface systems are challenging due to the large number of reservoir simulations required, and the need to preserve geological realism in matched models. This drawback increases significantly in big real fields due to the high heterogeneity of the geological models, the reservoir simulation computational time (which increases superlinearly). In embodiments, a framework is presented, based on artificial intelligence, that addresses these shortcomings. In embodiments, an example workflow is based on two main components: first, a new combination of model order reduction techniques (e.g., principal component analysis (PCA), kernel-PCA (k-PCA)) and artificial intelligence for parameterizing complex three-dimensional (3D) geomodels, known as “GeoNet”. Second, a derivative-free optimization framework to complete automatic history matching (AHM). In embodiments, this approach allows local changes to be performed in a reservoir at the same time that geological plausibility is conserved. In embodiments, using GeoNet, a full geological workflow may be recreated, obtaining the same high order of statistics as traditional geo-statistical techniques. In embodiments, Geo-Net allows for control of a full process with a low-dimensional vector and reproduction of a full geological workflow significantly faster than commercial geo-statistical packages.

### BRIEF DESCRIPTION OF THE DRAWINGS

FIG. 1 illustrates a conventional workflow for an example iterative geological model reduction and realization process.

FIG. 1A presents an exemplary process to compute a PCA given a set of Nr geomodels, and to then reconstruct the geomodels obtained to the original space, in accordance with various embodiments.

FIG. 2 is an illustrated process flow chart for the inferring sub-process of a deep neural network, in accordance with various embodiments.

FIG. 3 is a process flow chart for calculating a reconstruction PCA data set, in accordance with various embodiments.

FIG. 4 presents an example process flow for calculating the style loss, in accordance with various embodiments.

FIG. 5 presents an example process flow for a training loop of a DNN, in accordance with various embodiments.

FIG. 6 illustrates an exemplary optimization-based history-matching workflow, in accordance with various embodiments.

FIG. 7 illustrates an exemplary histogram matching based process to post-process petrophysical variables, in accordance with various embodiments.

FIG. 8 illustrates an exemplary histogram matching based process to post-process petrophysical variables that are conditioned to sedimentological variables, in accordance with various embodiments.

FIG. 9 illustrates an example petrophysical workflow, in accordance with various embodiments.

FIGS. 10A through 10D illustrate an exemplary deep neural network architecture, in accordance with various embodiments.

FIG. 11 illustrates a block diagram of a computer device suitable for practicing the present disclosure, in accordance with various embodiments.

FIG. 12 illustrates an example computer-readable storage medium having instructions configured to practice aspects of the processes of FIGS. 1A through 9, in accordance with various embodiments.

### DETAILED DESCRIPTION OF THE INVENTION

### Glossary

The following terms of art are used in this disclosure, and are presented here for easy reference.

Argmax: Argmax is an operation that finds the argument that gives the maximum value from a target function. Argmax is most commonly used in machine learning for finding the class with the largest predicted probability.

Backpropagation; The practice of fine-tuning the weights of a neural net based on the error rate (i.e., loss) obtained in the previous epoch (i.e., iteration.) Proper tuning of the weights ensures lower error rates, making the model reliable by increasing its generalization.

Deep Neural Network: Deep neural networks (DNN) is a class of machine learning algorithms similar to the artificial neural network which aims to mimic the information processing of the brain. A deep neural network (DNN) is an ANN with multiple hidden layers between the input and output layers. Similar to shallow ANNs, DNNs can model complex non-linear relationships.

Facies: The overall characteristics of a rock unit that reflect its origin and differentiate the unit from others around it. Mineralogy and sedimentary source, fossil content, sedimentary structures and texture distinguish one facies from another.

Facies Map: A map showing the distribution of different types of rock attributes or facies occurring within a designated geologic unit.

Histogram Matching: Histogram matching is a quick and easy way to “calibrate” one image to match another. In mathematical terms, it's the process of transforming one image so that the cumulative distribution function (CDF) of values in each band matches the CDF of bands in another image.

Principal Component Analysis: A popular technique for analyzing large datasets containing a high number of dimensions/features per observation, increasing the interpretability of data while preserving the maximum amount of information, and enabling the visualization of multidimensional data. Formally, PCA is a statistical technique for reducing the dimensionality of a dataset. This is accomplished by linearly transforming the data into a new coordinate system where (most of) the variation in the data can be described with fewer dimensions than the initial data.

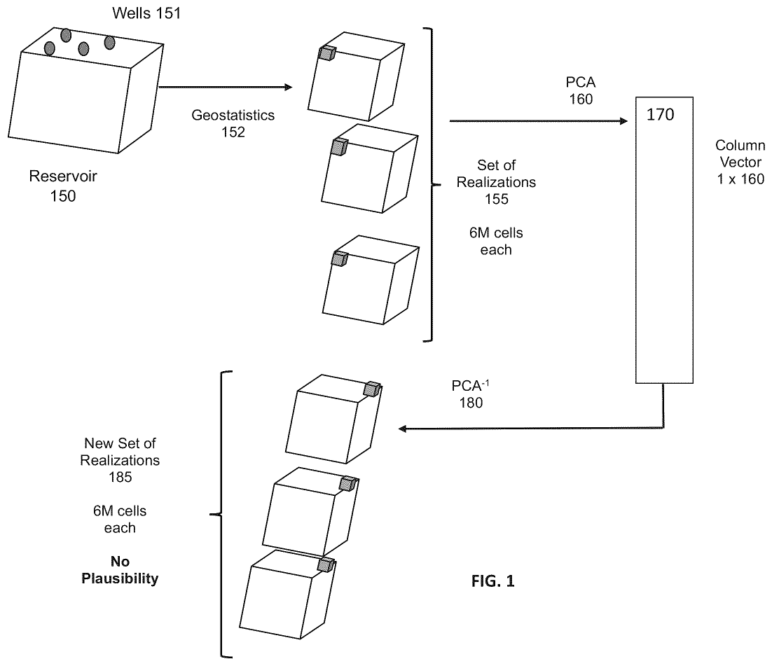

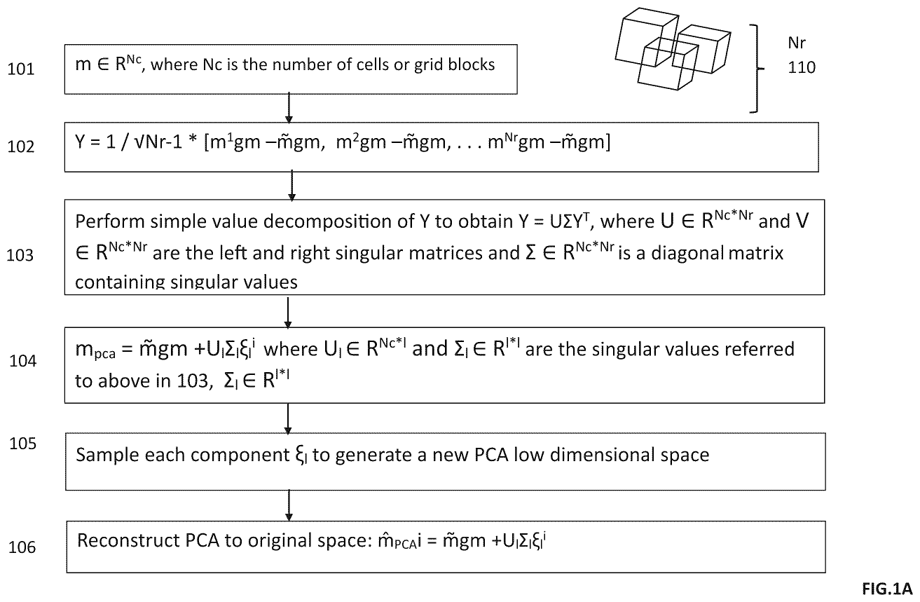

FIG. 1 illustrates an overview of a conventional approach to modelling an oil reservoir. Beginning at the top left of FIG. 1, there is shown reservoir 150. Drilled within reservoir 150 are several wells 151 (shown as dark ovals on the top of the reservoir volume). From these wells, hard geological data is obtained. It is noted, however, that the wells generally represent, collectively, less than 1% of the total volume of the reservoir. Taking the hard geological data obtained from wells 151, and using geostatistics, a set of models—shown as realizations 155—can be generated. An average reservoir may include, for example, a surface area of 50 km² and there may be 20 wells, each with a 20 cm bore, for example. Each of the realizations 155 in this example has 6 M cells, and in each cell, there are values for a set of geological variables, such as, for example, porosity, permeability, etc. Multiples of the 6 M cells may be used if greater resolution is desired.

The problem with these realizations 155, however, is that the traditional geostatistics used to generate them has to interpolate, from the hard data obtained from wells 151, for all the cells between the wells—which comprise 99% or more of the reservoir volume. This is done using some random mathematical processes, which may or may not (more often the case) match historical production. The set of realizations may be input to a simulator or forecaster, which, based upon the values in the various cells, can forecast oil production data for the reservoir. However, there is an inherent problem. When using the models 155 to forecast production values, there is often a mismatch between the forecast data and actual historical oil production data. So somehow the realizations 155 have to be optimized to better predict production data.

In order to further process the set of realizations 155, a mathematical transformation is first used to make the computations tractable. Thus, the set of realizations 155 is mapped, using principal component analysis (“PCA”), to a column vector 170 having only hundreds of dimensions. For example, column vector 170 is a 1×160 vector, replacing a 6M cell model. This dimensionality is much more tractable, and facilitates using one or more optimization algorithms on the column vector to tweak the information in the model. Thus, in general, an optimization algorithm is used to change the value of the column vector automatically to minimize the differences between the observed data and the simulated data obtained by a forecasting tool (e.g simulator) that takes a model as its input. In so doing, a very useful property of PCA is leveraged. An inverse PCA operation PCA-180 generates a new model of the original dimensionality (in this example, 6M cells), from the (now optimized) column vector 170, easily. Thus, if one uses an optimizing algorithm to operate on the column vector, and in so doing automatically changes the values of the column vector, the now optimized column vector may then be used to regenerate new—and hopefully more accurate—realizations of the model. To optimize a geomodel by operating on its original dimensionality (grid block level) is essentially impossible. However, it is noted, there are some conventional techniques that seek to manually change the values in cells of the model, to optimize it. However, this manual operation can literally take months to create a single new realization.

There is a significant problem with the conventional optimization methodology. The new set of realizations 185 of the geomodel lack plausibility after conventional optimization. That means that when one uses the new realizations 185 (and there may be one realization or many generated by reverse PCA) to forecast oil field production data, the model-based forecast very rarely matches the historical oil production data. For example, one may test the new set of realizations 185 by creating them from a geomodel 155 that uses original data from, say, the year 2000. One or more of the models may be respectively reduced via PCA to a column vector, optimized using an optimizer, and then their reconstructed version(s) 185 used to predict oil production data from the reservoir 150 for the years, for example, 2000-2023. and then compare these predictions to the actual known oil production data for the reservoir during those years (because it is all in the past, it is known). These predictions usually do not match the historical data, even when several iterations of the optimization process are performed. This problem is next described.

As noted above, various optimization methods have been used to automatically find a geological realization that matches the historical data. This problem is known as assisted or automatic history match (“AHM”). However, none of the conventional methods for AHM are satisfactory. As described in Basu et al., 2016, three major families of optimization algorithms have been used to solve automatic history match (AHM) problems. These include (i) filtering, (ii) gradient-based optimization, and (ii) derivative free methods. These are next described.

The first approach involves filtering methods. Most of these procedures aim at matching historical data by processing measurements sequentially in time. Filtering methods rely heavily on linearity assumptions but have been extended to deal with nonlinearities, as is the case of the Ensemble Kalman Filter (Gu & Oliver, 2005, p. 3; Jung et al., 2018). This technique, which has recently become popular, provides multiple reservoir models. Moreover, the computational cost is often reasonable. However, sometimes the ensemble of models unpredictably collapses into one model, and therefore, variability in the solutions is lost.

A second approach is that of gradient-based optimization methods. These methods leverage gradient information related to the cost function performance, especially when the number of variables is high (Anterion et al., 1989). Nevertheless, in practice, derivatives cannot always be computed, and even if they can, they often cannot be computed efficiently, in many real-world situations.

A third approach is derivative-free methods, which represent a flexible alternative in these cases (Chen et al., 2012). It should be emphasized that parameter reduction is an essential complement to derivative-free optimization, because convergence in these algorithms may be slow when the number of optimization variables is high (Basu et al., 2016). However, the general result of reduction techniques is, precisely as noted above, that geological models generated during the history match process are unrealistic and do not respect the statistics (e.g., variogram) of geomodelling workflows.

Thus, the abovedescribed approaches share several drawbacks: lack of geological plausibility during the process of history match as well as high computational time necessary to create a geological model.

To address these problems in the conventional approaches, the present disclosure provides a new methodology that overcomes the challenges of prior optimization methods. In embodiments, the disclosed workflow is based on two main components:
1) A new neural network (“Geo-Net”) that, in embodiments, creates complex high dimensional heterogeneous reservoir models at speeds orders of magnitude faster than prior geostatic techniques, while at the same time respecting geological plausibility with high geological realism, and
2) an optimization framework to complete the AHM.

In what follows, the history-matching approach is first described, highlighting those aspects that are related to simulation, and the generation of a plausible geological realization. Following that, an optimization framework, according to various embodiments, is described.

### Automatic History Match (“AHM”) Methodology

### 2. Sedimentological and Petrophysical Characterization/Model

A reservoir is typically characterized or modeled as a grid with petrophysical and sedimentological properties associated with each cell. As noted, hard data only exists for the actual wells (151 in FIG. 1), which are <1% of hard data of the total number of cells. For example, for a reservoir with 6 M cells, there is generally hard data for around 2000 cells, which is ˜0.005 of the total number of cells, or 0.5%. The exact values for these properties in each cell where there is no hard data (from well logging, seismic, etc) is obviously unknown and mathematical techniques must be used to infer these values. In exemplary embodiments of the present invention, two novel workflows are presented to infer these values based on the nature of the variables: a first workflow for sedimentological models (e.g., facies, lithotype, etc.), and a second workflow for petrophiscial properties (e.g., porosity, permeability, net-to-gross, etc). It is important to note that, from the mathematical point of view, integer values characterize sedimentological models and continuous variables characterize petrophysical properties.

### 2.1 Sedimentological Model

In one or more embodiments, sedimentological models, specifically facies models, may be characterized using a combination of a mapping of high-dimensional (grid-block level) variables to a set of uncorrelated low dimensional variables (PCA) with a deep neural network architecture. In embodiments, the main goals of this combination are:
a) to provide a tool that can generate fast (e.g., in seconds) realistic geological models while at the same time respecting high-order statistics (e.g., variograms, histograms, continuity of the geo-bodies, etc. . . . ) of the modeled geological volume;
b) to provide a parameter reduction process that allows a user to formulate history matching as an optimization problem where the variables are the coefficients of a reduced basis (for example, a few hundreds of components instead of millions of cells of a real geological model). Moreover, a smaller search space mitigates to some extent the ill-conditioned nature of the optimization problem being addressed; and
c) to remove the stochasticity of traditional geo-statistics, having a one-to-one representation between a parameter reduction space and a full geological model.

In embodiments, an example workflow includes two different steps. First, PCA is used to map a reservoir in a reduced dimensional space. Once the PCA is obtained, new geomodels are created by sampling each component of the PCA and making a reconstruction of the model to the original space (grid block level, millions of cells). However, conventional PCA presents several limitations, such as (i) the lack of geological realism (creating geobodies that are not possible in real geological models), (ii) not respecting the hard data, and (iii) not respecting geo-spatial correlation statistical variables, such as variograms. Therefore, in embodiments, a second step involves the use of a deep neural network (“DNN”) to post-process the reconstruction of the PCA and correct its limitations. Each of these steps is next described.

### 2.1.1 Principal Component Analysis (PCA)

As described above, the main objective of the PCA is to use parameterization techniques to map a model m to a new lower dimensional variable ξ∈ [symbol] ^{N}^{ₗ}, where |<Nc is the reduced dimension. It is assumed that the value I is given (I being the length of the column vector), but, in embodiments, it may be computed using different criteria such as total energy of singular values.

FIG. 1A presents an exemplary process to compute a PCA given a set of Nr geomodels, and to then reconstruct the geomodels obtained to the original space. FIG. 1A is thus a detailed process flow of the overview as shown in FIG. 1. With reference to FIG. 1A, beginning at 101 an ensemble of Nr models is generated using geomodeling techniques such as, for example, two-point or multipoint geostatistics. Then, at 102, these models may be assembled into a centered data matrix Y, where [symbol] ∈ [symbol] ^{N}^{_{c}} represents realization i, [symbol] ∈ [symbol] ^{N}^{_{c}} is the mean of the Nr realizations, the subscript ‘gm’ indicates that these realizations are generated using traditional geostatistics and N_{c} is the number of cells or grid block.

From 102, process flow continues to 103, where a singular value decomposition of centered data matrix Y is performed, to obtain left and right singular matrices U∈ [symbol] ^{N}^{_{c}}^{xNr}^{ᵣ}, V∈ [symbol] ^{N}^{ᵣ}^{xN}^{ᵣ} as shown at 103. From 103, process flow proceeds to 104, where a new PCA model is generated. In this case, ideally I (dimension of the projection)<<Nc, such as in the example of FIG. 1, where a 6 M cell model was decomposed to a 1×160 vector. From 104, process flow moves to 105, where each component ξₗ is sampled, and a new PCA low dimensional space is generated. Finally, from 105 process flow moves to 106, where the realizations are reconstructed to the original space, using the equation \hat{m}_{pca}ⁱ=\tilde{m}_{gm}+U_{I}Σ_{I}ξₗⁱ. Where Uₗ∈ [symbol] ^{N}^{_{c}}^{xl}, Σₗ∈ [symbol] ^{l×l} and ξₗ∈ [symbol] ^{l}

It is important to note that while PCA applies linear mapping of model m onto a set of principal components, thereby considerably easing the computational load, PCA also has several inherent drawbacks. It is noted that PCA is a linear mapping, but the geological model that is being created is non-linear, and this presents issues. First, it is difficult to characterize heterogenous and complex sedimentological environments such as deltaic, for example. Second, there is no guarantee that hard-data are respected in the reconstructed realizations, and third, these realizations generated with PCA (i.e., the reconstructions, such as described at 106 in FIG. 1A) do not respect statistical variables with respect to sophisticated geostatistical techniques, such as multipoint geostatistics.

Thus, in exemplary embodiments, to correct these inherent problems of standard PCA decomposition and realization reconstruction, post-processing using a deep neural network may be used, as next described. In what follows, this DNN is referred to as GeoNet, a name used by the inventors for their DNN.

2.1.2 Post Processing of the PCA Using a Deep Neural Network (GeoNet)

In embodiments, a novel deep neural network may be used to post-process the reconstruction of the PCA so as to cure the drawbacks described above. In embodiments, GeoNet processing includes two different sub-processes: a first sub-process of training the deep neural network (GeoNet) to generate geological models. This process is termed “inferring” by the inventors. A second sub-process includes training the deep neural network to generalize for the creation of geological models. These sub-processes are next described.

2.1.2.1 Inferring of the Deep Neural Network

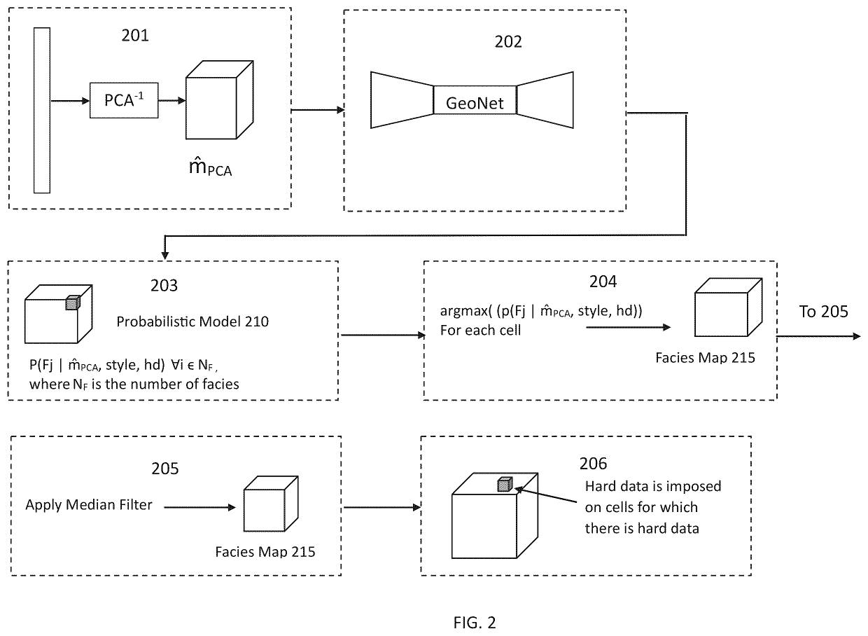

FIG. 2 is an illustrated process flow chart for the inferring sub-process of the Geo-Net. With reference to FIG. 2, in embodiments, beginning at 201, given a lower dimensional variable ξₗ∈ [symbol] ^{l} such as l<<N_{c}, a PCA reconstruction (106 in FIG. 1A, which is the reverse PCA 180, as shown in FIG. 1) is applied to the vector obtain a geological realization \hat{m}_{pca}ⁱ∈ [symbol] ^{N}^{_{c}}. From there, at 202, the input data \hat{m}_{pca}ⁱ is provided to an already trained GeoNet deep learning model. The output of the trained GeoNet is shown at 203. This output is a probabilistic model 210, which is a realization where each cell of the model has the probability to be a facies j given an \hat{m}_{pca}ⁱ model, one style image, and the hard data, namely p(Fⱼ|\hat{m}_{pca}ⁱ, style, hd) for all j∈N_{F}, where N_{F} is the number of facies, style is the style image and hd is the input hard-data. A style image is an image which contains the geological features that one wants to reproduce in a model of a geological volume, such as, for example, shape of the geo boundaries, sedimentological environments, etc. From 203 process flow moves to 204, where, in order to obtain the final facies map (shown at 204), the argmax operator is applied to the probability obtained for each cell. Having this now final facies map, process flow moves to 205, where a median filter is applied to the facies map, so as to have more continuity between different geobodies and so that noise or isolated unrealistics facies cells are removed. In embodiments, the processing at 205 is optional, and in alternate embodiments other kinds of filters may be applied, such as, for example, a max polling filter. From 205, process flow moves to 206 where, in order to guarantee that the model conforms to the hard data for any cells for which the hard data is available, those hard data values are forced into those cells. In embodiments, this step is also optional.

2.1.2.2 Training of the Deep Neural Network

In embodiments, the second sub-process performed by the GeoNet is, as noted, to generalize for the creation of geological models. The objective here is to obtain a set of weights for the DNN such that, given a new—and unseen during the training process—geological PCA model, such a new model may be accurately post processed using deep learning. In embodiments, such a deep learning (“DL”) model provides a high-quality geological model that respects hard data, respects statistical variables such as the variogram, and provides realistic geological models m_{DL_pca}=f_{W}(m_{pca}), where f_{W} denotes the deep learning model transform net, subscript W indicates the trainable parameters within the network, and m_{DL_pca}∈ [symbol] ^{N}^{_{c}} is the resulting geomodels output by the desired DNN. Specifically, in one or more embodiments, different loss functions may be used to train the deep learning model, including (i) supervised-learning-based reconstruction loss, (ii) style loss, and (iii) hard data loss.

2.1.2.2.1 Supervised-Learning-Based Reconstruction Loss

One of the most important challenges of GeoNet is to create a new semi-random geomodel that was neither seen nor used during the construction of the PCA. In other words, to provide an exemplary DNN with the capability to generalize the post-processing to obtain completely new random geological models never seen during training. This process is known as generalization. As an analogy, it is relatively simple to train a child to ride a single bicycle on a single street. After many tries, the child may simply memorize the way that bicycle works, and all the “obstacles” on that now well know street. If that is all the child is trained to do, they will likely fail at riding a different type of bicycle in a totally new territory. A robust training, on the other hand, prepares the child to ride *any* bicycle, on *any* possible street. This ability is “generalization.” In order to train the DNN to be able to generalize, instead of calculating the difference between m_{gm}ⁱ and its reconstruction (once the m_{gm}ⁱ projected, obtaining \hat{ξ}ₗⁱ), in a PCA space \hat{m}_{pca}ⁱ, a perturbation (e.g., gassian noise) is introduced to \hat{ξ}ₗⁱ, which disrupts the precise correspondence pairs while maintaining major geological features. Thus, the DNN must be able to deal with models on which it was never trained. In other words, we want to avoid overfitting of the deep neural network, which is when the DNN “memorizes” the optimization of its training set, and being limited to only optimizing accurately models identical to the training set models.

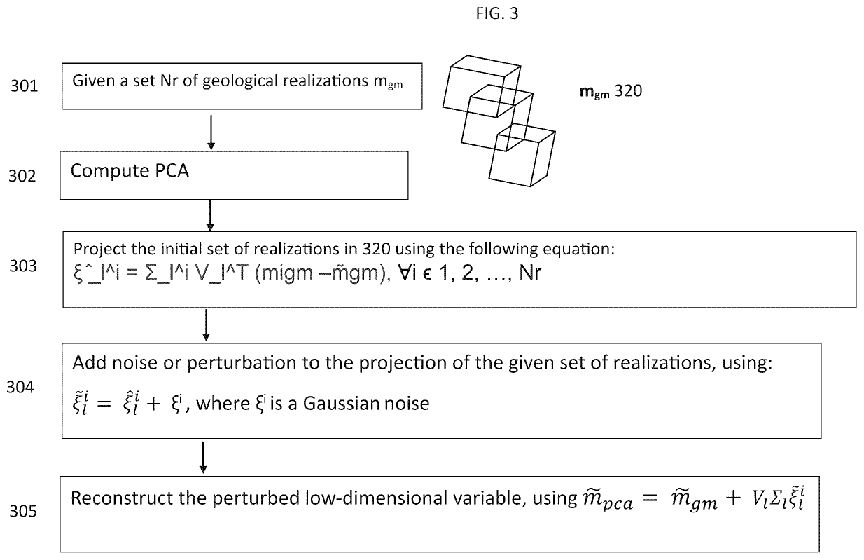

As noted, in embodiments, the DNN is trained using three loss functions, the first of which is the reconstruction loss. In embodiments, in order to compute the reconstruction loss, the first step is to calculate a reconstruction PCA data set. This is illustrated in FIG. 3, next described.

With reference to FIG. 3, process flow begins at 301, with a set of geological realizations m_{gm} 320. Taking this set of geological realizations Nr as input, at 302 the PCA is computed. For example, the set of realizations may include 500 models. From 302, process flow continues to 303, where the initial set of realizations given in 301 is projected onto a PCA space \hat{ξ}ₗⁱ, using the equation ξ\hat{ }_|\hat{ }i=Σ_|\hat{ }i V_|\hat{ }T (migm−\tilde{m}gm), ∀iϵ1, 2, . . . , Nr, as shown at 303. From 303, process flow moves to 304, where some noise is added to the projected variable, thereby obtaining a now perturbed low-dimensional variable \tilde{ξ}ₗⁱ. Finally, process flow moves to 305, where, in embodiments, the perturbed low dimensional variable is reconstructed to the original geomodels spaces, \tilde{m}_{pca}, using the equation \tilde{m}_{pca}=\tilde{m}_{gn}+VₗΣₗ\tilde{ξ}ₗⁱ, as shown at 305, where process flow ends.

It is noted that one of the main limitations of conventional methods on post-processing of the PCA reconstructions is the necessity to truncate the continuous output of the PCA or DNN to obtain a final facies map (defined by categorical variables). This creates two important drawbacks: (a) the borders of the geo-bodies are sometimes not well defined; and (b) current techniques are limited to being used in reservoirs with just two facies, or with three facies where one of them is limited to being a transition zone between the other two. These two drawbacks dramatically limit the use of the state-of-the-art approach to solve real-world problems due to the fact that the majority of the reservoirs has more than two facies w/o a transition zone.

Accordingly, in exemplary embodiments, a new approach is implemented that addresses these significant limitations in the state of the art. In exemplary embodiments, the neural network calculates, as an output for each cell of the geomodel, the probability that it is a facies j, given: a \hat{m}_{pca}ⁱ model, one style image, and the input hard data, for each of the possible facies. Or, symbolically:

p(Fⱼ|\hat{m}_{pca}ⁱ,style,hd), for all j∈N_{F},

where N_{F} is the total number of facies. While there may be 3, 5, 7 or more possible facies in many real world examples, in embodiments, a reservoir with any number of facies may be handled. This new approach introduces several changes in the traditional workflow, as follows:
1) the final number of channels of the DNN (Geo-Net) is equal to the number of facies, where each of them provides the probability of a cell belonging to each of the N_{F} facies;
2) in embodiments, a SoftMax layer may be introduced at end of the DNN architecture to ensure that the sum of the probability for all facies is equal to one; and
3) a cross-entropy loss function is used (instead of the conventional mean square error) to calculate the style, hard data and reconstruction loss functions.

In embodiments, the loss function for the reconstruction loss is defined as:

−Σᵢ₌₁^{F}p(x)log(q(x))=−Σᵢ₌₁^{F}prob_targetᵢ^{j} log(prob_dnnᵢ(f_{W}(\tilde{m}_{pca}^{j}))),

for j=1, . . . , Nr,
where F is the number of facies, prob_targetᵢ^{j} is the target probability for the realization j and the facies and prob_dnnᵢ(f_{W}(\tilde{m}_{pca}^{j})) is the probability for the facies j of the DNN output given a \tilde{m}_{pca}^{j}.

2.1.2.2.3 Hard-Data Loss

In generating geological models, it is important that the final geomodels respect the hard data. Thus, for any cells for which there is well-derived hard-data, this hard-data must be constant for the generation of any realization. For this reason, in embodiments, a hard data loss is introduced. As was done for the reconstruction loss described above, in embodiments a cross-entropy loss function may be used to reproduce the hard data of \tilde{m}_{pca} and m_{PCA}, as follows:

−hΣᵢ₌₁^{F}prob_{target}_{ᵢ}^{j} log(prob_{dnn}_{ᵢ}(f_{W}(\tilde{m}_{pca}^{j})))−hΣᵢ₌₁^{F}prob_targetᵢ^{j} log(prob_dnnᵢ(f_{W}(m_{pca}^{j}))), j=1, . . . ,Nr,

where h is a selection vector, with hⱼ=1 indicating the presence of hard data at cell j and hⱼ=0 indicating the absence of hard data for that cell.

It is noted that one of the main advantages of using the cross-entropy loss function is that it is easy to implement and optimize. First, most neural network frameworks provide built-in functions for cross-entropy loss and its gradients. Moreover, the cross-entropy loss also has a smooth and convex shape, which makes it easier for gradient-based optimization methods to find the global minimum. Yet another advantage of cross-entropy loss is that it is invariant to scaling and shifting of the predicted probabilities. This means that multiplying or adding a constant to the predicted probabilities does not affect the cross-entropy loss value, as long as they are still between 0 and 1. In embodiments, this can be useful for regularization and calibration of the model's outputs.

2.1.2.2.4 Style Loss

One of the main challenges in creating a geomodel is geological realism. Thus, in embodiments, in order to obtain more realistic geomodels, the notion of style loss is introduced and used. The objective of style loss is to transfer the features from one training or style image/model to the output of the neural network, transferring high and low orders of statistics.

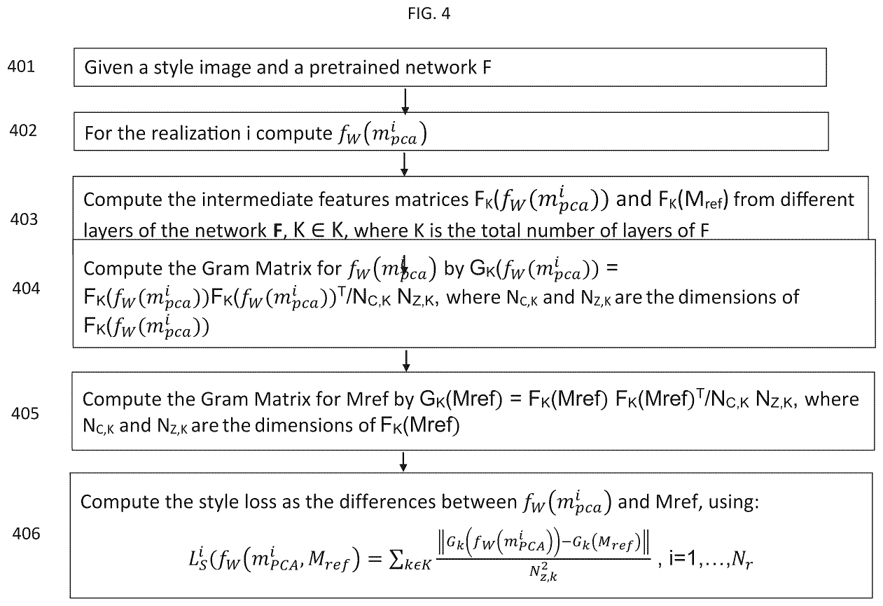

FIG. 4 presents an example process flow for calculating the style loss. This is next described. Process flow begins at 401, with a given style image Mref, and a pre-trained network F which has been validated as giving good results for different task such as image classification or segmentation (e.g., C3D). From there, process flow moves to 402 where, for the realization i, f_{W}(m_{pca}ⁱ) is computed. From 402, process flow moves to 403, where the intermediate features matrices F_{K}(f_{W}(m_{pca}ⁱ)) and F_{K}(M_{ref}) are computed from different layers of the network F, K∈K, where K is the total number of layers of F. From there process flow proceeds to 404, where the Gram Matrix for f_{W}(m_{pca}ⁱ) is computed by G_{K}(f_{W}(m_{pca}ⁱ))=F_{K}(f_{W}(m_{pca}ⁱ))F_{K}(f_{W}(m_{pca}ⁱ))^{T}/N_{C,K} N_{Z,K}, where N_{C,K} and N_{Z,K} are the dimensions of F_{K}(f_{W}(m_{pca}ⁱ)).

From 404, process flow proceeds to 405, where the Gram Matrix for Mref is computed by G_{K}(Mref)=F_{K}(Mref) F_{K}(Mref)^{T}/N_{C,K} N_{Z,K}, where N_{C,K} and N_{Z,K} are the dimensions of F_{K}(Mref). Finally, from 405 process flow moves to 406, where the style loss is based on the differences between f_{W}(m_{pca}ⁱ) and reference model

### Mref:

$${L}_{S}^{i} ( {f}_{W} ( {m}_{PCA}^{i} , {M}_{ref} ) = {Σ}_{k ∈ K} \frac{‖ {G}_{k} ( {f}_{W} ( {m}_{PCA}^{i} ) ) - {G}_{k} ( {M}_{ref} ) ‖}{{N}_{z , k}^{2}} , i = 1 , … , {N}_{r}$$

Where ∥·∥ may be any type of normalization, such as, for example, mean absolute error, L1, L2, L3, etc.

2.1.2.2.5 Total Loss

Finally, given the three loss components (style, reconstruction and hard-data) calculated as described above, the total loss is computed as sum of the previous loss function weighs for a given input vector W, as follows:

LOSSₜₒₜₐₗ=w₁Loss_{style}+w₂Loss_{reconstruction}+w₃Loss_{hard-data}

where w1, w2 and w3 are set by a user, depending upon how they see the importance of relative contributions of the style loss, reconstruction loss and hard-data loss to plausibility of the final model.

2.1.2.2.6 Example Final Workflow

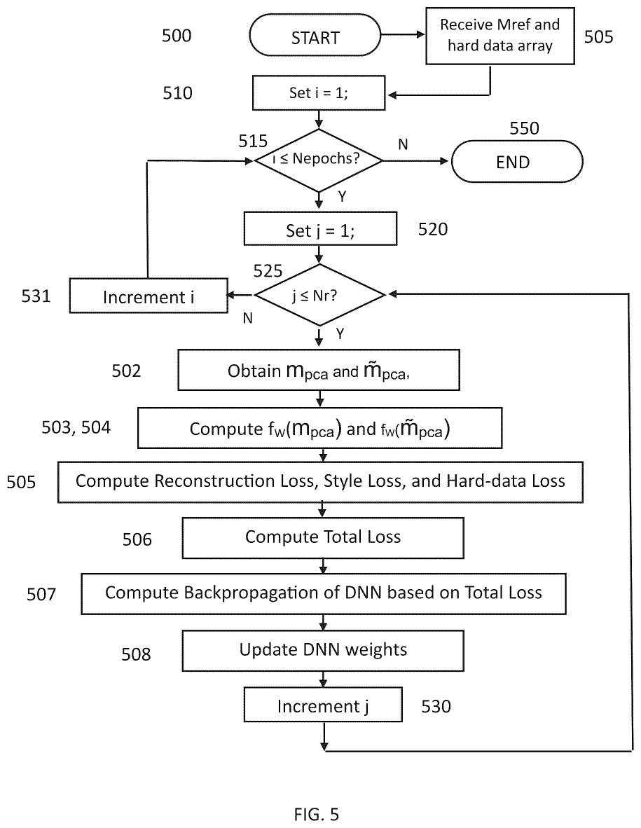

FIG. 5 presents an example process flow for a general training process for the DNN, in other words, the complete training loop, in accordance with various embodiments. The process flow of FIG. 5 utilizes a “style image.” A style image is an image which contains the geological features that one wants to reproduce in the Geonet such as, for example, shape of the geo boundaries, sedimentological environments, etc. The process of FIG. 5 contains an inner loop and an outer loop, such that in the inner loop the training is done for each realization 1 through Nr, and in the outer loop this entire inner loop processing is repeated a number of times referred to as “Nepochs”, to suffle the Nr dataset. In embodiments, Nepochs is a user-definable number for how many times the training is repeated in order to optimize the weights of the DNN (GeoNet). There are various options for setting Nepochs. For example, the training may be stopped once the loss function reaches a defined target, such as, for sample e-3. Alternatively, the training may be stopped when the loss function is flat. In embodiments, the loss may be monitored during training, Nepochs determined after running several experiments and monitoring the results.

With reference to FIG. 5, process flow begins at 500, where the flow starts. From 500, process flow moves to 505, where a style image Mref, and a hard data array, containing the available hard data for the reservoir or geological volume, are received or obtained. From 505, process flow moves to 510, where the outer loop counter, i, is set to a value of 1. From 510, process flow continues to 515, which is a query block, asking if the value of i is ≤the desired times training is to be repeated, Nepochs. If the response is “Yes” at 515, then process flow proceeds to 520, where the inner loop counter i is set equal to 1.

From 520, process flow continues to 525, which is a query block, asking if the value of j is ≤Nr, the number of realizations of the geomodel. If the response is “Yes” at 525, then process flow proceeds to 502, where the various training steps are performed. Thus, with reference to FIG. 5, at 502, data is obtained for each of m_{pca} and \tilde{m}_{pca}. From 502 process flow moves to 503, where f_{w}(m_{pca}) is computed, and then to 504, where f_{w}(\tilde{m}_{pca}) is computed. It is noted that, for conciseness, the processing at 503 and 504 is combined in FIG. 5.

From 504 process flow moves to 505, where each of the reconstruction loss, style loss and hard-data losses are computed as set forth above, and then to 506, where the total loss, which is the sum of those three loss types, calculated as set forth above, is computed.

From 506 process flow moves to 507, where the backpropogation of the DNN based on the total loss (as computed at 506) is computed (using known techniques), and finally, from 507, process flow moves to 508, where the weights of the DNN are updated, for this run of the inner loop. From 508 process flow continues to 530, which increments the inner loop counter j, and from 530, process flow continues to query block 525, to determine if j has exceeded Nr. Thus, the inner loop will be repeated until j exceeds Nr, which gives a “No” response at query block 525. When that condition is satisfied, then processing flow continues to 531, where the outer loop counter i is incremented, and process flow continues to query block 515, where it is checked if outer loop counter has now exceeded Nepochs. If a “No” is the response at query block 515, the process flow continues through the inner loop again, after setting inner loop counter j back to one, so that the processing is repeated another Nr times.

Once outer loop counter i has reached Nepochs, and thus a “No” is returned at query block 515, then as shown, process flow continues to End block 550, and the training loop shown in FIG. 5 is completed, with the DNN weights now set.

It is noted that, in embodiments, alternate or different stopping criteria for the training process could be implemented such as, for example, a target total loss function at 506, as opposed to fixed loop counters i and j.

2.1.2.2.7 Example Deep Neural Network Architecture

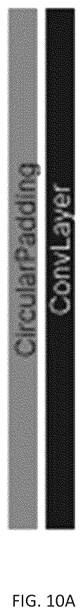

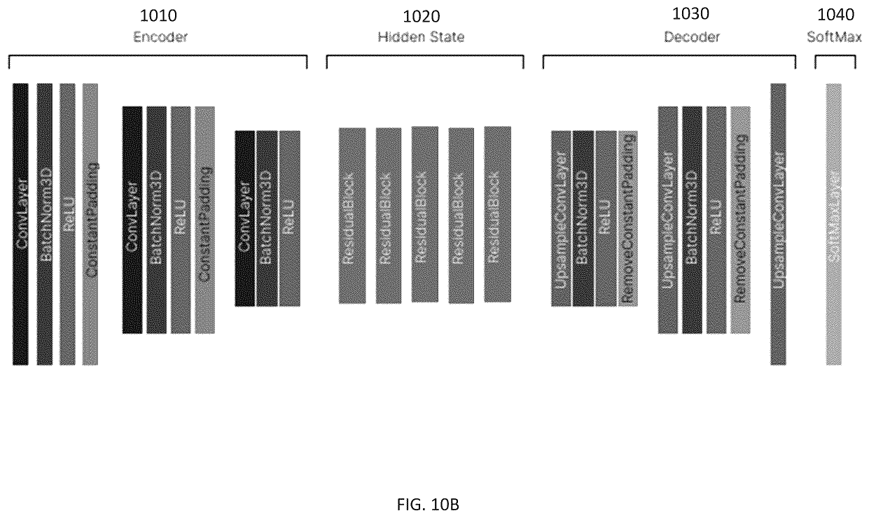

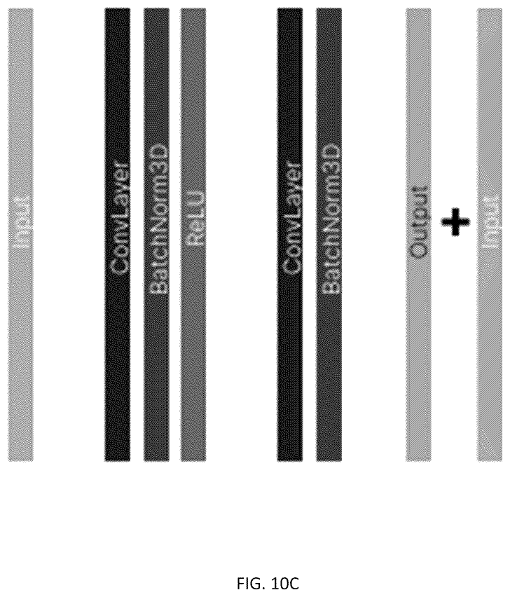

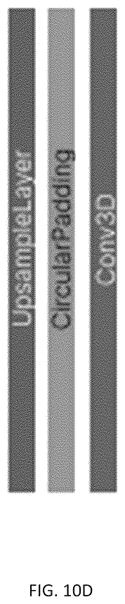

In embodiments, an example main architecture that may be used for an exemplary neural network is an encoder-decoder. This architecture consists of 4 stages as shown in FIG. 10B:

Encoder 1010: Transforms the 3D input into a smaller vector with more channels, each representing a different feature. In this example, the encoder is composed, but not limited to, of a sequence of 3 convolutional 3D as described below:
ConvLayer block, shown in FIG. 10A, includes a circular padding and a convolutional layer with a kernel size between 3 to 9, stride between 1 to 2
Batch normalization 3D layer
Relu activation function
Constant zero padding in all 3D directions in every encoder layer except the last one.

Hidden state 1020 includes a sequence of, but not limited to, 5 Residual 3D blocks as shown in FIG. 10C. In the exemplary Residual 3D block, in embodiments, the input may be passed through a series of convolutional blocks (as illustrated in FIG. 10A, each comprising a circular padding and a convolutional layer), batch normalization block and relu block, and finally, a return of the output of those layers+the original input, as shown in FIG. 10C.

Decoder 1030: In embodiments, this stage transforms the hidden state vector 1020 into the 3D output. In embodiments, this decoder is the inverse model of the encoder. In this example, the decoder may include, but is not limited to, a sequence of 3 upsample convolutional 3D as described below:
Upsample Convolutional 3D block as shown in FIG. 10D composed of an upsample layer, using the nearest neighbor to increase the dimension of the input data, circular padding layer and finally a convolutional layer [with a kernel size between 3 to 9, stride between 1 to 2, circular padding, and upsample factor between zero (no upsample) and 3.
Batch normalization 3D layer in every decoder layer except the last one.
Relu activation function in every decoder layer except the last one.
Remove the constant zero padding that was added in the encoder (described above)

SoftMax Layer 1040: As described above, in embodiments, an exemplary model predicts the probability of each facies to be true. This means that for each facies there will be a 3D map with the probability for this facies to be true. In this layer the argmax algorithm is used to select the facie with more probability and, in embodiments, this 4D vector of probabilities (3D map plus the probability of each facie) is converted into a 3D map of integer numbers.

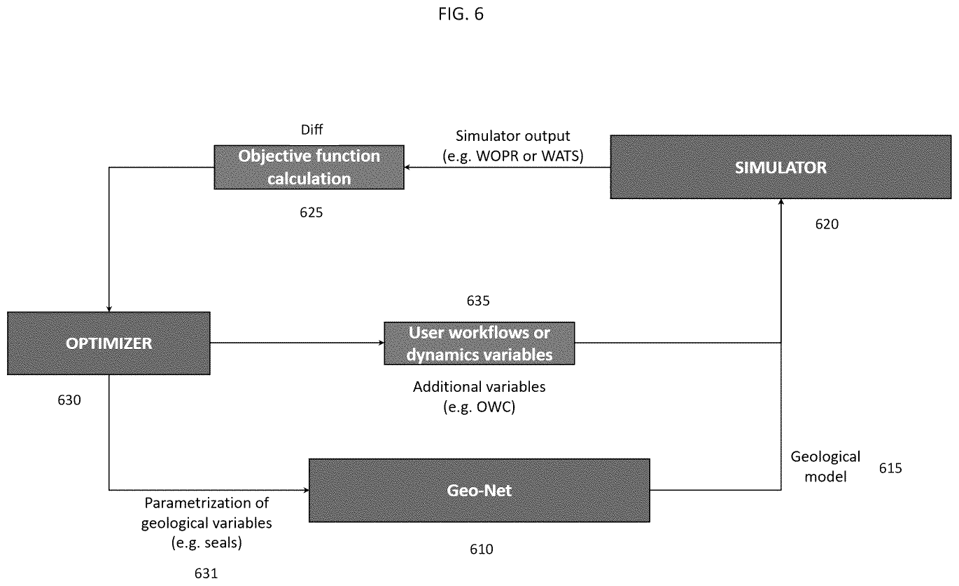

FIG. 6 presents an overall higher-level view workflow utilizing the detailed processes shown in FIGS. 2-5. With reference thereto, FIG. 6 shows an exemplary optimization-based history-matching workflow, in accordance with various embodiments. It is assumed that the input of the optimization process lives in a parametric space of few hundreds of dimensions. To transform a vector of this parametric space into a full facies map of the size of the reservoir (approximately 7 million), in embodiments, an inverse Principal Component Analysis (PCA) transformation is applied. This step is referred to as “Parametrization of geological variables” 631 in FIG. 6. However, because PCA is a linear transformation, it is not flexible enough to reconstruct a geologically plausible facies map. To avoid this problem, the inventors created the GeoNet (short for the “Geological Neural Network”), which, in embodiments, may be trained to enforce geological plausibility and generate more realistic geological models in a short time, in embodiments, just a few seconds.

In one or more embodiments, a simulator is used to predict the measurements that are desired to be matched with the observations made in the reservoir, such as, for example, production rates of all of the wells of the reservoir. Finally, in embodiments, an optimization process is implemented (optimizer 630 in FIG. 6), where, by modifying the input vector of just hundreds of parameters, the error between the observed measurements of the reservoir and the simulated ones may be minimized.

In the example system of FIG. 6 there are three major components or processing blocks. These include optimizer 630, GeoNet 610, and simulator 620. As noted, GeoNet 610 is a deep neural network approach to generating plausible geological models in just seconds. Optimizer 630 implements an optimization process that exploits GeoNet's 610 speed and accuracy to find solutions that minimize the error between observed measurement in the reservoir and that obtained by simulator 620, which may be, for example, a simulator or any forecasting tool used to obtain production rates such as surrogate, this is the objective function described in 625.

For example, in embodiments, for simulator 620, simple forecasting of the rates of oil production or water saturation maps or pressure maps, may be used. For example, in embodiments a reservoir simulator may be used.

It is noted that in the optimization problem, certain variables that are geological variables may be minimized, such as, for example, the dimension of the aquifer, fluid properties, and the like. In one or more embodiments, these additional variables could be optimized directly without entering into GeoNet 610.

2.2 Petrophysical Model

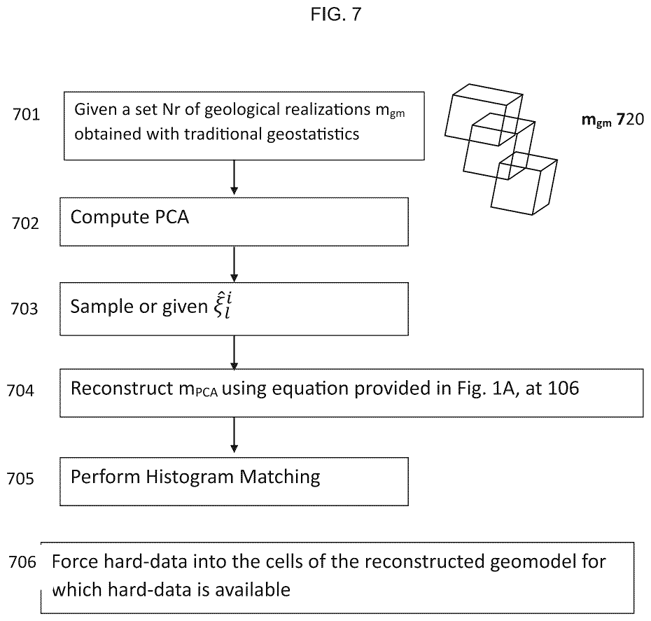

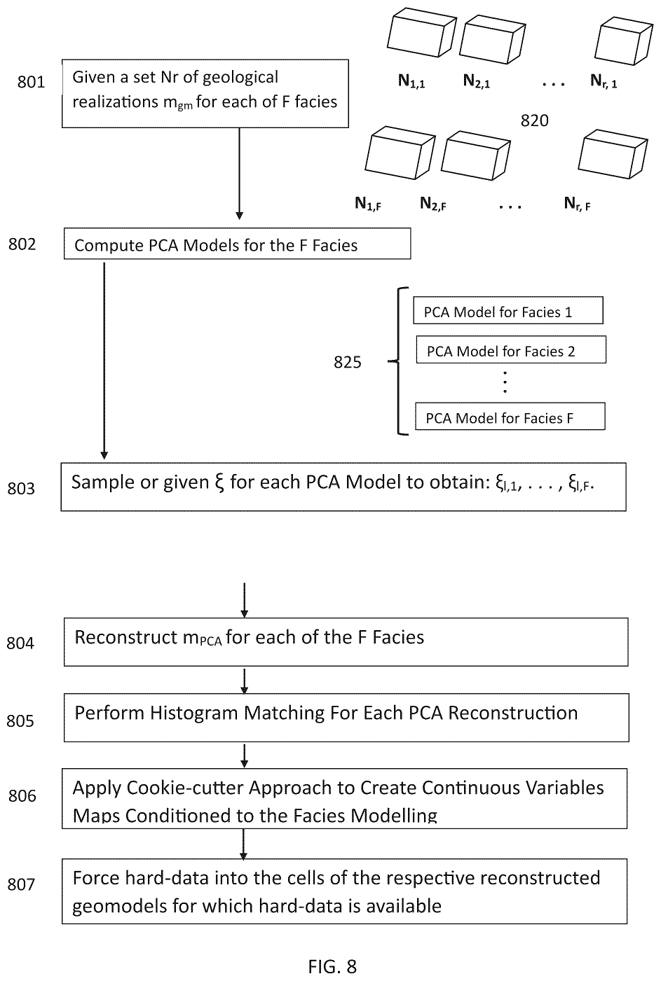

For continuous variables, a similar workflow to that described above for the integer variables, was developed. Here there are two possible use cases: (1) the petrophysical model is independent of the sedimentological model, and (2) the petrophysical model has to be conditioned to sedimentological model. It is important to note that the first workflow, shown in FIG. 7, is a special case of the second workflow, shown in FIG. 8, where the facies map is equal to one.

2.2.1 Case where Petrophysical Model is Independent of Sedimentological Model

FIG. 7 presents an example process flow for the case where the petrophysical model is independent of the sedimentological model, in accordance with various embodiments. With reference thereto, process flow begins at 701, where there are a set of realizations obtained using traditional geostatistics such as Kriging and/or Sequential Gaussian Simulation (“SGS”). From 701, process flow proceeds to 702, where a PCA model is generated using the process shown in, for example, 160 of FIG. 1, or 302 of FIG. 3. From 702 process flow continues to 703, where a new \hat{ξ}ₗⁱ is calculated or given. Process flow then continues to 704, where a reconstruction of \hat{m}_{pca}ⁱ is performed using process 106 of FIG. 1. Then, at 705, histogram matching is done to convert the output of the PCA to the probability distribution given from the hard data. Finally, process flow then moves to 706, where the hard-data is forced into the cells for which we have hard data.

### 2.2.1.1 Histogram Matching

Conventionally, as described above, a new PCA is not able to respect statistics, such as histograms or variograms. For that reason, similar to the workflow applied for GeoNet, post-processing is also necessary here (with the continuous petrophysical variables) to rectify the output of the PCA. In embodiments, this rectification may be done using Histogram Matching. Histogram matching is based on the idea that given an accumulative probability distribution Fᵣ obtained from the reconstruction of the PCA vector as m_{PCA}, it is desired to convert to the accumulative probability distribution target given in the hard data, F_{z}. In embodiments, for each level of the petrophysical property G₁, we compute Fr(G₁)=Fz(G₂), and this results in histogram matching function M(G₁)=G₂. In embodiments, M is then applied to all of the cells of the model.

It is important to note that this technique is similar to the post-processing implemented for sedimentological model with a DNN, as described above, according to various embodiments.

2.2.1 Case where Petrophysical Model are Conditioned to the Sedimentological Model

The workflow for this second use case is similar to the previous first one, with the main difference between them being that the petrophysical variable, such as porosity, for each facies is calculated, and subsequently a cookie-cutter filtering map is applied. FIG. 8 presents an example process flow, according to various embodiments, next described.

FIG. 8 presents an example process flow for the use case where the petrophysical model is conditioned to the sedimentological model, in accordance with various embodiments. With reference to FIG. 8, process flow begins at 801, where a set of realizations Nr is provided, for each facies. So, for example, with Nr=500, and a geobody with N_{F}=7 facies, there will be a total of 3,500 (Nr*N_{F}) realizations 820. Process flow then continues to 802, where a PCA is computed for each set of realizations (shown as each row in FIG. 8 at 801), and thus the output is F PCA models 825, as shown, where there is a PCA model for each of {facies 1, facies 2, . . . , facies F}. From 802 process flow continues to 803, where, in analogous manner to 105 of FIG. 1A, each of the F PCA models is sampled to obtain sampled PCA vectors ξ_{I,1}, . . . , ξ_{I,F}. From 803 process flow proceeds to 804, where, for each sampled PCA vector ξ, a reconstruction of the PCA is performed, and thus a set of F reconstructions is obtained. From 804, process flow proceeds to 805, where histogram matching is performed for each PCA reconstruction.

From 805, process flow proceeds to 806, where a cookie-cutter approach is applied to create continuous variables maps conditioned to facies modeling. Cookie-cutter is a simple technique where each cell takes the petrophysical property assigned to its given facies. For example, if a cell has facies 5, the petrophysical property for facies 5 is assigned to this cell. Finally, from 806 process flow continues to 807, where the hard data is forced into each cell for which we have hard data. Process flow then ends at 807.

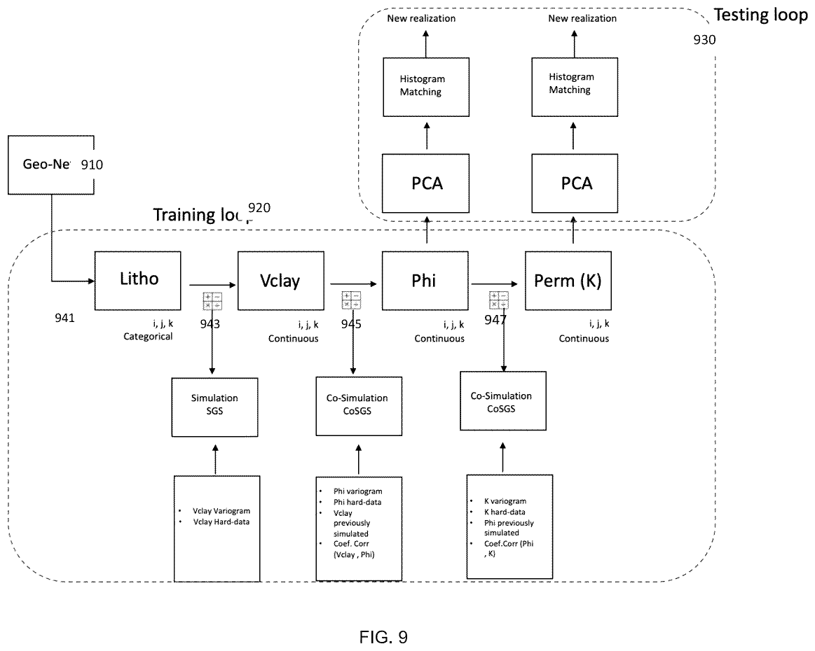

FIG. 9 is a special example of the petrophyscial workflow conditioned to facies, in accordance with various embodiments. In this workflow, given a sedimentological map such as lithotype, traditional geostatistic techniques are initially used to compute Vclay 943, porosity 945 and permeability 947. Specifically, SGS I used for for Vclay, co-kriging, for porosity and co-kriging for permeability. Finally, in order to obtain porosity and permeability the workflow shown in the process flow of FIG. 7, described above, is implemented.

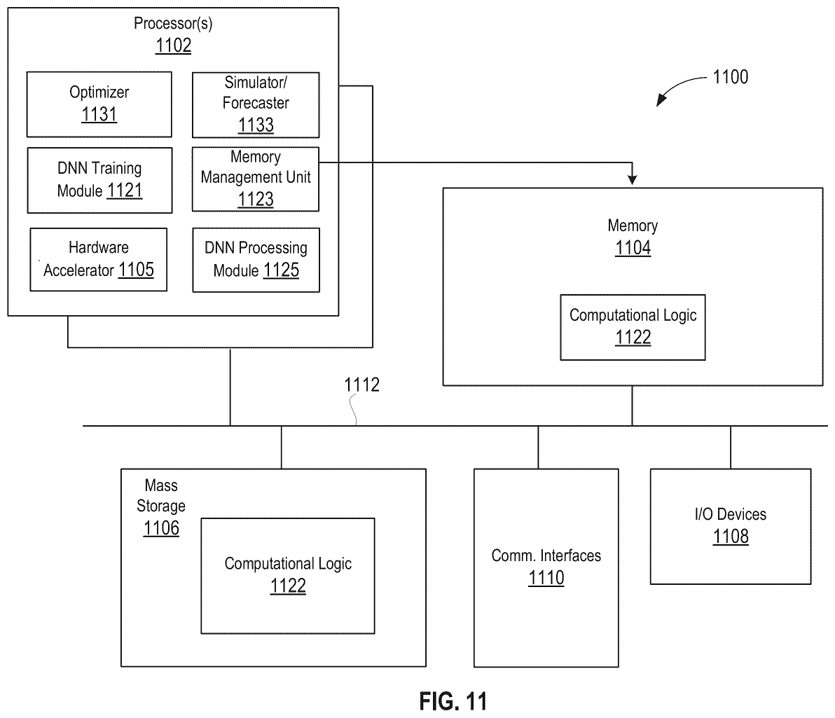

FIG. 11 illustrates a block diagram of a computer device suitable for practicing the present disclosure, in accordance with various embodiments. As shown, computer device 1100 may include one or more processors 1102, and system memory 1104. Each processor 1102 may include one or more processor cores, and hardware accelerator 1105. An example of hardware accelerator 1107 may include, but is not limited to, programmed field programmable gate arrays (FPGA). Each processor 1102 may also include memory execution unit (MEU) 1123, and each of DNN training module 1121, DNN processing module 1125, as well as Optimizer 1131 and Simulator/Forecaster 1133. Each of these performs the functions described above in FIG. 6, and in the detailed process flows of FIGS. 1A-5, 7 and 8.

Computer device 1100 may also include system memory 1104. In embodiments, system memory 1104 may include any known volatile or non-volatile memory. Additionally, computer device 1100 may include mass storage device(s) 1106 (such as SSDs 1109), input/output device interfaces 1108 (to interface with various input/output devices, such as, mouse, cursor control, display device (including touch sensitive screen), and so forth) and communication interfaces 1110 (such as network interface cards, modems and so forth). In embodiments, communication interfaces 1110 may support wired or wireless communication, including near field communication. The elements may be coupled to each other via system bus 1112, which may represent one or more buses. In the case of multiple buses, they may be bridged by one or more bus bridges (not shown).

In embodiments, system memory 1104 and mass storage device(s) 1106 may be employed to store a working copy and a permanent copy of the executable code of the programming instructions of an operating system, one or more applications, and/or various software implemented components of the various components shown in FIGS. 6 and 9, and the processes illustrated in FIGS. 1A through 5, and 7-8, collectively referred to as computational logic 1122. The programming instructions implementing computational logic 1122 may comprise assembler instructions supported by processor(s) 1102 or high-level languages, such as, for example, C, that can be compiled into such instructions. In embodiments, some of computing logic may be implemented in hardware accelerator 1105. In embodiments, part of computational logic 1122, e.g., a portion of the computational logic 1122 associated with the runtime environment of the compiler may be implemented in hardware accelerator 1105.

The permanent copy of the executable code of the programming instructions or the bit streams for configuring hardware accelerator 1105 may be placed into permanent mass storage device(s) 1106 and/or hardware accelerator 1105 in the factory, or in the field, through, for example, a distribution medium (not shown), such as a compact disc (CD), or through communication interfaces 1110 (from a distribution server (not shown)).

The number, capability and/or capacity of these elements 1102-1133 may vary, depending on the intended use of example computer device 1100, e.g., whether example computer device 1100 is a smartphone, tablet, ultrabook, a laptop, a server, a set-top box, a game console, a camera, and so forth. The constitutions of these elements 1110-1131 are otherwise known, and accordingly will not be further described.

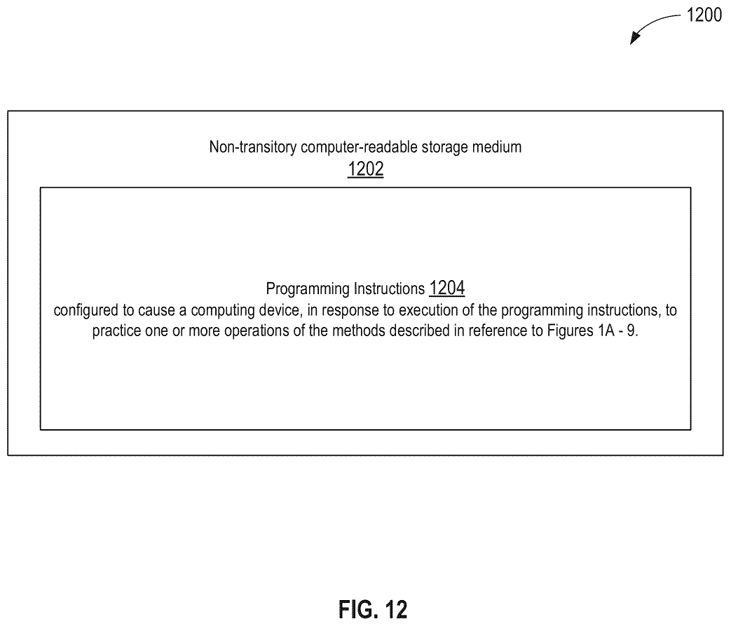

FIG. 12 illustrates an example computer-readable storage medium having instructions configured to implement all (or portion of) software implementations of the various components shown in FIGS. 6 and 9, and/or practice (aspects of) processes illustrated in FIGS. 1A, 2-5 and 7-8, earlier described, in accordance with various embodiments. As illustrated, computer-readable storage medium 1202 may include the executable code of a number of programming instructions or bit streams 1204. Executable code of programming instructions (or bit streams) 1204 may be configured to enable a device, e.g., computer device 1100, in response to execution of the executable code/programming instructions (or operation of an encoded hardware accelerator 1105), to perform (aspects of) processes performed by the various components shown in FIGS. 6 and 9, and/or practice (aspects of) processes illustrated in FIGS. 1A, 2-5 and 7-8. In alternate embodiments, executable code/programming instructions/bit streams 1204 may be disposed on multiple non-transitory computer-readable storage medium 1202 instead. In embodiments, computer-readable storage medium 1202 may be non-transitory. In still other embodiments, executable code/programming instructions 1204 may be encoded in transitory computer readable medium, such as signals.

Referring back to FIG. 11, for one embodiment, at least one of processors 1102 may be packaged together with a computer-readable storage medium having some or all of computing logic 1122 (in lieu of storing in system memory 1104 and/or mass storage device 1106) configured to practice all or selected ones of the operations earlier described with reference to FIGS. 1A through 9. For one embodiment, at least one of processors 1102 may be packaged together with a computer-readable storage medium having some or all of computing logic 1122 to form a System in Package (SiP). For one embodiment, at least one of processors 1102 may be integrated on the same die with a computer-readable storage medium having some or all of computing logic 1122. For one embodiment, at least one of processors 1102 may be packaged together with a computer-readable storage medium having some or all of computing logic 1122 to form a System on Chip (SoC). For at least one embodiment, the SoC may be utilized in, e.g., but not limited to, a hybrid computing tablet/laptop.

Although certain apparatus, mono-transitory computer-readable storage media, methods of computing, and other methods constructed or implemented in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

### REFERENCES

Anterion, F., Eymard, R., & Karcher, B. (1989). Use of parameter gradients for reservoir history matching. SPE Symposium on Reservoir Simulation.
Basu, S., Das, A., Paola, G. D., Ciaurri, D. E., Droz, S. E., Llano, C. I., Ocheltree, K. B., & Torrado, R. R. (2016). Multi-Start method for reservoir model uncertainty quantification with application to robust decision-making. International Petroleum Technology Conference.
Chen, C., Gao, G., Hohl, D., Jin, L., Vink, J. C., & Weber, D. (2012). Assisted History Matching Using Three Derivative-free Optimization Algorithms (SPE 154112). 74th EAGE Conference and Exhibition Incorporating EUROPEC 2012, cp-293.
Fetkovich, M. J. (1971). A simplified approach to water influx calculations-finite aquifer systems. Journal of Petroleum Technology, 23(07), 814-828.
Fontaine, M. C., Togelius, J., Nikolaidis, S., & Hoover, A. K. (2020). Covariance matrix adaptation for the rapid illumination of behavior space. Proceedings of the 2020 Genetic and Evolutionary Computation Conference, 94-102.
Gonzalez, R. C., & Woods, R. E. (2008). Digital image processing, prentice hall. Upper Saddle River, NJ.
Gu, Y., & Oliver, D. S. (2005). History matching of the PUNQ-S3 reservoir model using the ensemble Kalman filter. SPE Journal, 10(02), 217-224.
Hansen, N., & Ostermeier, A. (2001). Completely derandomized self-adaptation in evolution strategies. Evolutionary Computation, 9(2), 159-195.
Jung, S., Lee, K., Park, C., & Choe, J. (2018). Ensemble-based data assimilation in reservoir characterization: A review. Energies, 11(2), 445.
Kingma, D. P., & Ba, J. (2014). Adam: A method for stochastic optimization. ArXiv Preprint ArXiv:1412.6980.
Li, X., Chen, H., Qi, X., Dou, Q., Fu, C.-W., & Heng, P.-A. (2018). H-DenseUNet: Hybrid densely connected UNet for liver and tumor segmentation from CT volumes. IEEE Transactions on Medical Imaging, 37(12), 2663-2674.
Liu, Y., & Durlofsky, L. J. (2021). 3D CNN-PCA: A deep-learning-based parameterization for complex geomodels. Computers & Geosciences, 148, 104676.
López-Tapia, S., Ruiz, P., Smith, M., Matthews, J., Zercher, B., Sydorenko, L., Varia, N., Jin, Y., Wang, M., Dunn, J. B., & others. (2021). Machine learning with high-resolution aerial imagery and data fusion to improve and automate the detection of wetlands. International Journal of Applied Earth Observation and Geoinformation, 105, 102581.
Oliver, D. S., & Chen, Y. (2011). Recent progress on reservoir history matching: A review. Computational Geosciences, 15(1), 185-221.
Peaceman, D. W. (1978). Interpretation of well-block pressures in numerical reservoir simulation (includes associated paper 6988). Society of Petroleum Engineers Journal, 18(03), 183-194.
Pyrcz, M. J., & Deutsch, C. V. (2014). Geostatistical reservoir modeling. Oxford university press.
Raissi, M., Perdikaris, P., & Karniadakis, G. E. (2019). Physics-informed neural networks: A deep learning framework for solving forward and inverse problems involving nonlinear partial differential equations. Journal of Computational Physics, 378, 686-707.
Rasmussen, A. F., Sandve, T. H., Bao, K., Lauser, A., Hove, J., Skaflestad, B., Klöfkorn, R., Blatt, M., Rustad, A. B., Swvareid, O., & others. (2021). The open porous media flow reservoir simulator. Computers & Mathematics with Applications, 81, 159-185.
Rodriguez-Torrado, R., Ruiz, P., Cueto-Felgueroso, L., Green, M. C., Friesen, T., Matringe, S., & Togelius, J. (2022). Physics-informed attention-based neural network for hyperbolic partial differential equations: Application to the Buckley-Leverett problem. Scientific Reports, 12(1), 1-12.
Sarabian, M., Babaee, H., & Laksari, K. (2021). Physics-informed neural networks for improving cerebral hemodynamics predictions. ArXiv Preprint ArXiv:2108.11498.
Sarabian, M., Babaee, H., & Laksari, K. (2022). Physics-informed neural networks for brain hemodynamic predictions using medical imaging. IEEE Transactions on Medical Imaging.
Tran, D., Bourdev, L., Fergus, R., Torresani, L., & Paluri, M. (2015). Learning spatiotemporal features with 3d convolutional networks. Proceedings of the IEEE International Conference on Computer Vision, 4489-4497.
Vo, H. X., & Durlofsky, L. J. (2015). Data assimilation and uncertainty assessment for complex geological models using a new PCA-based parameterization. Computational Geosciences, 19(4), 747-767.

1. An apparatus for computing, comprising:
an input interface, configured to receive:
a geological model, the geological model including a 3D array of cells representative of a geological volume;
a processor implementing a deep neural network (“DNN”), the processor configured to generate a probabilistic geological model, the probabilistic geological model including, for each cell, and for a set of J facies, a probability of the cell being each of the J facies, given the geological model and other predetermined conditions; and
an output interface, configured to output the probabilistic model.

2. The apparatus for computing of claim 1, wherein the other predetermined conditions include: a style image, and hard data for predefined regions of the geological volume.

3. The apparatus for computing of claim 2, wherein at least one of:
the probabilistic model is expressed as:
p(Fⱼ|\hat{m}_{pca}ⁱ,style,hd), for all j∈N_{F},
where \hat{m}_{pca}ⁱ is a PCA reconstruction of the geological model, N_{F} is the number of facies, style is the style image and hd is hard-data for a subset of the geological volume;
the style image is an image that contains geological features to be reproduced in a geological model of the geological volume; or
the style image is an image that contains geological features to be reproduced in a geological model of the geological volume, and wherein the geological features include one or more of:
shape of the geological boundaries and sedimentological environments.

4-5. (canceled)

6. The apparatus for computing of claim 1, wherein the processor is further configured to apply an argmax function to each cell of the probabilistic model to obtain a facies map, with the same number of cells as the probabilistic model, with a facies value for each cell.

7. The apparatus for computing of claim 6, wherein at least one of:
the processor is further configured to take the facies map as input and at least one of:
apply a median filter to the facies map to obtain an output geological model; or
apply a median filter to the facies map, then impose hard data on each cell of the facies map for which there is hard data, to obtain an output geological model; or
the DNN is a fully trained GeoNet.

8. (canceled)

9. The apparatus for computing of claim 1, wherein the geological model is a reverse PCA reconstruction.

10. A method of training a neural network (“NN”), comprising:
obtain a reconstruction m_{pca} of a PCA vector obtained from a geological model of a geological volume;
obtain a reconstruction \tilde{m}_{pca} of a perturbed PCA vector created from the geological model;
compute a set of NN weights for each of the reconstruction of the PCA vector and the reconstruction of the perturbed PCA vector;
compute a total loss, including a style loss, based on the respective NN weights; and
compute a backpropagation of the NN based upon the total loss.

11. The method of claim 10, further comprising at least one of:
first receiving a style image and a hard data array for the geological volume;
repeating the method for each of Nr times, where Nr is a number of geological model realizations from which the m_{pca} was generated; or
repeating the method for each of Nr times, where Nr is a number of geological model realizations from which the m_{pca} was generated, in an inner loop, and wherein the inner loop for each of the Nr realizations is performed a number of times Nepochs, in an outer loop.

12. The method of claim 10, wherein compute the total loss further includes to compute both a reconstruction loss and a hard-data loss.

13. The method of claim 12, wherein each of the reconstruction loss, style loss and hard-data loss are weighted using user defined weights, in the total loss.

14. The method of claim 12, further comprising, following computation of the back propagation, updating the DNN weights

15-16. (canceled)

17. One or more non-transitory computer-readable storage media comprising a set of instructions, which, when executed on a processor including a DNN module, cause the DNN module to:
receive a geological model, the geological model including a 3D array of cells representative of a geological volume;
generate a probabilistic geological model, the probabilistic geological model including, for each cell, and for a set of J facies, a probability of the cell being each of the J facies, given the geological model and other predetermined conditions; and
output the probabilistic model.

18. The one or more non-transitory computer-readable storage media of claim 17, wherein the other predetermined conditions include: a style image, and hard data for predefined regions of the geological volume.

19. The one or more non-transitory computer-readable storage media of claim 18, wherein the probabilistic model is expressed as:
p(Fⱼ|\hat{m}_{pca}ⁱ,style,hd), for all j∈N_{F},
where \hat{m}_{pca}ⁱ is a PCA reconstruction of the geological model, N_{F} is the number of facies, style is the style image and hd is hard-data for a subset of the geological volume.

20. The one or more non-transitory computer-readable storage media of claim 18, wherein the style image is an image that contains geological features to be reproduced in a geological model of the geological volume.

21. The one or more non-transitory computer-readable storage media of claim 20, wherein the geological features include one or more of: shape of the geological boundaries and sedimentological environments.

22. The one or more non-transitory computer-readable storage media of claim 19, wherein the processor is further configured to apply an argmax function to each cell of the probabilistic model to obtain a facies map, with the same number of cells as the probabilistic model, with a facies value for each cell.

23. The one or more non-transitory computer-readable storage media of claim 22, wherein at least one of:
the processor is further configured to take the facies map as input and at least one of:
apply a median filter to the facies map to obtain an output geological model; or
apply a median filter to the facies map, then impose hard data on each cell of the facies map for which there is hard data, to obtain an output geological model; or
the DNN is a fully trained GeoNet.

24. (canceled)

25. The one or more non-transitory computer-readable storage media of claim 17, wherein the geological model is a reverse PCA reconstruction of a geological model of the geological volume.
